(19) United States
(12) Patent Application Publication
(10) Pub. No.: US 2018/0323489 A1
(43) Pub. Date: Nov. 8, 2018

(54) Truss Reinforced Radome Crown Structure Shock Absorbing And Recoiling Sysytem

(71) Applicant: Howard R. Vermillion, JR., Northrdge, CA (US)

(72) Inventor: Howard R. Vermillion, JR., Northrdge, CA (US)

(21) Appl. No.: 15/479,868

(22) Filed: Apr. 5, 2017

Related U.S. Application Data
(60) Provisional application No. 62/318,489, filed on Apr. 5, 2016.

(51) Int. Cl. H01Q 1/00; H01Q 1/42

(52) U.S. Cl. CPC H01Q 1/005; F16F 15/067; H01Q 1/42

(57) ABSTRACT

A truss reinforced radome crown structure shock absorbing and recoiling system that is utilized with an aircraft antenna adapter plate or other satellite communication (SAT-COM) structure to an aircraft airframe or fuselage and for allowing for pressurized expansion and contraction of the fuselage, or to protect against a bird strike incident or rapid decompression event. There are multiple design configurations of the system, with all configurations utilizing an actuating recoiling strut. In first and second design configurations, the strut is used on an adapter plate or adjacent to attachment lugs. A third design configuration uses a strut with a sliding mechanism. In all configurations after decompression, a bird strike incident or rapid decompression event the system will allow a fuselage to return to an original position.

### TECHNICAL FIELD

The invention generally pertains to aircraft structural systems, and more particularly to a truss reinforced radome crown structure shock absorbing and recoiling system that is utilized for any type of SAT-COM connectivity device to allow for pressurized expansion and contraction, and to protect an aircraft from damage resulting from a bird strike incident or rapid decompression event if the fuselage skin were to tear directly under a radome crown structure.

### BACKGROUND ART

In the modem world, there are many methods of transportation. One of the most widely used methods, for trips of all distances and durations, is by aircraft, which are utilized for personal, commercial, military/government, and for other purposes. One of the most important capabilities of modern aircraft is the inclusion of an advanced communication system. A major component on many communication systems is a radome/antenna that functions in combination with communication satellite(s), air to air or air to ground data links.

Typically, a radome/antenna(s) or other SAT-COM hardware is attached either within an aircraft's nose cone, or onto an outer surface of the aircraft. When radome/antennas are mounted to an outer surface, a platform or adapter plate is typically required to support the fairing and radome/antenna assembly. An improved method of supporting the fairing utilizes a truss design.

Typically, an aircraft's fuselage will expand or contract as the pressure varies. For example, an aircraft fuselage can grow by up to 0.30 inches. When this occurs, items such as radomes/antennas that are usually affixed onto the fuselage can be damaged if not allowed to flex as the fuselage expands.

The solution to this problem would be to provide a push/pull shock absorber or fuselage expansion link that would allow an antenna/radome or other communication hardware to absorb the forces of pressurization an aircraft experiences. Optimally, a strut with shock absorbing and recoiling capability would be utilized. A strut or fuselage expansion link could be placed at each attachment point of a radome/antenna mounting plate and would allow the plate to absorb the expansion and contraction of the fuselage while returning the fuselage to its original position after landing once cabin pressure equals neutral barometric pressure on the ground.

To further the utility, a complete system could be utilized to protect an aircraft from normal fuselage expansion and contraction, a rapid decompression event or a bird strike incident depending on whether the struts are mounted horizontally for a bird strike incident or vertically as for a rapid decompression event. Without this flexible protection an extreme event could cause catastrophic damage and/or loss of life. The system could utilize a strut that also includes sliding actuators which allow the strut to move horizontally in pull, pull/push or push directions to absorb a bird strike incident or if attached between lugs and a radome fairing in a vertical mariner the strut would allow normal fuselage expansion or protect a radome crown structure from a rapid decompression event.

All of the above elements of the system would be beneficial and would be a significant improvement to current aircraft technology. The system would protect an airframe from a catastrophic incident such as a bird strike or rapid decompression if the fuselage were to tear directly under a radome crown structure. A shock absorbing and recoiling crown structure would be light weight, decrease costs and increase safety.

A search of the prior art did not disclose any literature or patents that read directly on the claims of the instant invention. However, the following U.S. patents are considered related:

| PAT. NO. | INVENTOR | ISSUED |
|---|---|---|
| U.S. Pat. No. 8,839,919 | Horikaina et al | Sep. 23, 2014 |
| U.S. Pat. No. 9,249,727 | Matos | Feb. 2, 2016 |
| 2017/0016502 | Simotmeaux et al | Jan. 19, 2017 |

The U.S. Pat. No. 8,839,919 patent discloses a shock absorber that is attached coaxially with a reciprocating rod driven by a reciprocating unit for absorbing an impact force. A hollow rod is mounted within an outer cylindrical body, with an accommodating space is formed there between. A spring force toward one end portion side of the hollow rod is applied to the outer cylindrical body by a compression coil spring. When the impact force is applied to the hollow rod, a liquid flows from one chamber to another chamber, whereby a resistance force is applied to the hollow rod.

The U.S. Pat. No. 9,249,727 patent discloses a deflector to deflect birds and debris from an air intake duct of an aircraft jet engine. The deflector includes a plurality of elongated members disposed on the duct in spaced relation to each other with each member having two end segments and a central segment disposed between the two end segments, and a plurality of guiding members, each mounted for movement along the perimeter of the duct and coupled to one end segment of an elongated member. The elongated member is movable by a respective pair of guiding members between a retracted position and a deployed position. When in the deployed position, the central segments are situated to impede the ingress of debris into the duct.

The 2017/0016502 publication discloses a magnetic shock absorber having a first body slidably coupled to a second body via a first bearing arranged to move in sliding engagement with a first counter-face portion. A first array of magnets associated with the first body is arranged to magnetically interact with a second array of magnets associated with the second body to absorb compression or extension loads applied to the shock absorber.

For background purposes and indicative of the art to which the invention relates, reference may be made to the following patent:

| PAT. NO. | INVENTOR | ISSUED |
|---|---|---|
| U.S. Pat. No. 5,044,614 | Rau | Sep. 13, 1991 |
| U.S. Pat. No. 5,065,959 | Bhatia | Nov. 19, 1991 |
| U.S. Pat. No. 5,158,267 | Pascal | Oct. 27, 1992 |
| U.S. Pat. No. 5,480,129 | Gilsdorf | Jan. 2, 1996 |
| U.S. Pat. No. 5,752,692 | Crabtree | May 19, 1998 |
| U.S. Pat. No. 7,959,135 | Voelkel | Jun. 14, 2011 |
| 2013/0082142 | Li | Apr. 4, 2013 |

### DISCLOSURE OF THE INVENTION

A truss reinforced radome crown structure shock absorbing and recoiling system that allows/compensates for fuselage expansion during aircraft cabin pressurization and to absorb the force of a bird strike or survive a catastrophic event cause by rapid decompression.

There are multiple design configurations of the system: the first design configuration is for mounting an antenna adapter plate, or other satellite communication (SAT-COM) crown structure and hardware to an aircraft fuselage, allowing for pressurized expansion and contraction of the fuselage. Second and third design configurations provide recoiling shock absorbing protection from both a bird strike incident or rapid decompression event.

In all of the design configurations the system comprises an actuating recoiling strut with a housing, a male cap, an actuating rod and a compression spring. In lieu of a spring, other resilient members can be utilized, and the functionality of the system can be accomplished by use of other means or materials such as hydraulic or pneumatic devices, and rubber or elastic materials. Also, the system can be attached by means of cables, rods or tubes which may include spherical bearings or heim joints.

The housing is preferably made of a metal such as aluminum, but can also be made of other materials including carbon fiber or composite materials, and the size of the housing can vary depending on the requirements of use.

The first design configuration is primarily used with an aircraft's adapter plate for antenna mounting and allows for fuselage expansion during pressurization. In the second design configuration the actuating recoiling strut can be used with any crown structure system to allow a crown structure to recoil when struck by a bird or in reaction to a rapid decompression event. In the third design configuration, the actuating recoiling strut is attached to a slide mechanism that is mounted at either an actuating base plate and/or attachment lugs. Alternately, when the system is utilized with an adapter plate that supports both antennas and/or an aircraft's fairing skirt and radome, the entire adapter plate functions as a single large unitary shock absorber.

In view of the above disclosure the primary object of the invention is to provide a truss reinforced radome crown structure shock absorbing and recoiling system that provides an actuating recoiling strut that is used with or without an adapter plate to accommodate aircraft fuselage expansion during cabin pressurization and to protect against a bird strike incident or rapid decompression event.

In addition to the primary object, it is also an object of the invention to provide a truss reinforced radome crown structure shock absorbing and recoiling system that:
significantly increases safety,
can lower operating and/or insurance costs,
is easy to install,
can be retrofit on existing aircraft
can be used on other types of vehicles including trains, sea vessels, and automobiles,
can be used with various types of SAT-COM systems including air to air and air to ground,
is durable and long lasting,
does not interfere with or affect the operation of a SAT-COM system
can be sold as an OEM component or an after-market product,
is cost effective from both a manufacturer's and consumer's point of view.

These and other objects and advantages of the present invention will become apparent from the subsequent detailed description of the preferred embodiment and the appended claims taken in conjunction with the accompanying drawings.

### BRIEF DESCRIPTION OF THE DRAWINGS

FIG. 1 is a top plan sectional view of a truss reinforced radome crown structure shock absorbing and recoiling system's actuating recoiling strut in a pulling mode.

FIG. 2 is a top plan sectional view of the system's strut showing an actuator's position to provide pulling forces.

FIG. 3 is a top plan sectional view of the system's strut showing an actuator's position to provide pushing and pulling forces.

FIG. 4 is a top plan sectional view of the system's strut showing an actuator's position to provide pushing forces.

FIG. 5 is a top plan sectional view of one embodiment of a sliding mechanism that utilizes a shock absorbing strut to allow lug attachments to slide horizontally under tension absorbing a bird strike, or if the shock absorbing strut is attached vertically to the sliding plate it will allow the crown structure to spring open in a rapid decompression event, returning to its initial position after the incident.

FIG. 6 is an orthographic side view of the system's strut attached to a mounting plate and utilized in a vertical orientation.

FIG. 7 is a side elevational view of a design configuration of the system's strut with fixed attachment means on one end.

FIG. 8 is a side elevational view of a design configuration of the system's strut with fixed attachment means on both ends.

FIG. 9 is a side elevational view of an alternate design configuration of the system's strut with attachment means on one end, and spring actuated compression/torsion from 100 pounds to 60,000 pounds.

FIG. 10 is an orthographic side view of the system's functional design configuration showing the actuating recoiling struts attached to a fairing for protection against a bird strike incident or rapid decompression event.

FIG. 11 is an orthographic top view of the system's functional design configuration showing the actuating recoiling struts attached to a fairing for protection against a bird strike incident or rapid decompression event.

### BEST MODE FOR CARRYING OUT THE INVENTION

The best mode for carrying out the invention is presented in terms that disclose a preferred embodiment with multiple functional design configurations of a truss reinforced radome crown structure shock absorbing and recoiling system. The first functional design configuration of the system is for mounting an antenna adapter plate, or other SAT-COM crown structure and hardware to an aircraft fuselage, allowing for pressurized expansion and contraction of the fuselage. The second and third functional designs provide recoiling shock absorbing protection from both a bird strike incident or rapid decompression event.

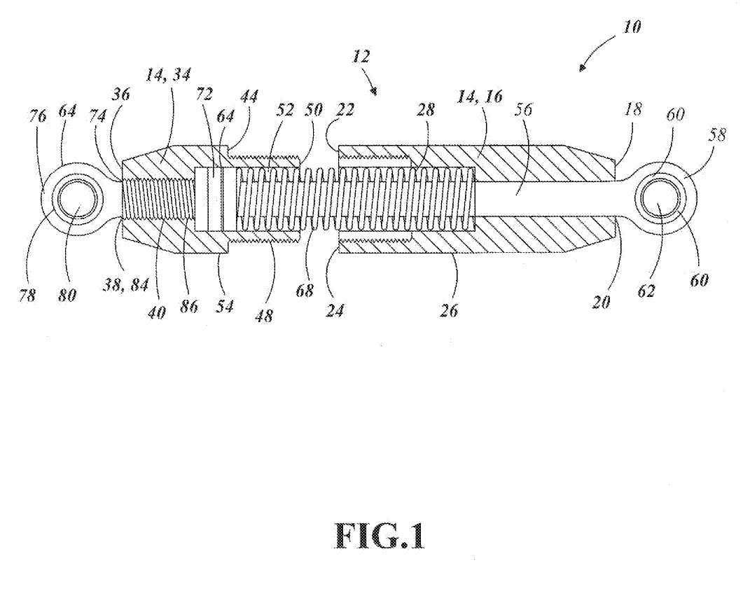

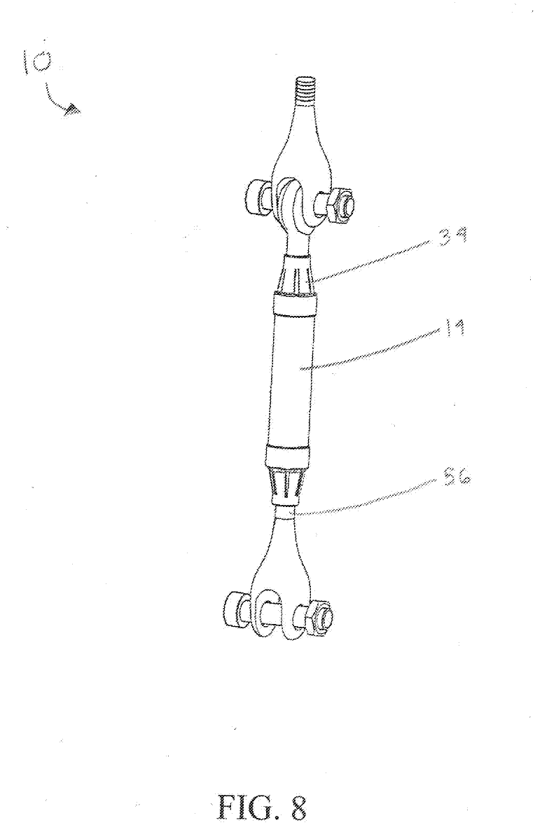

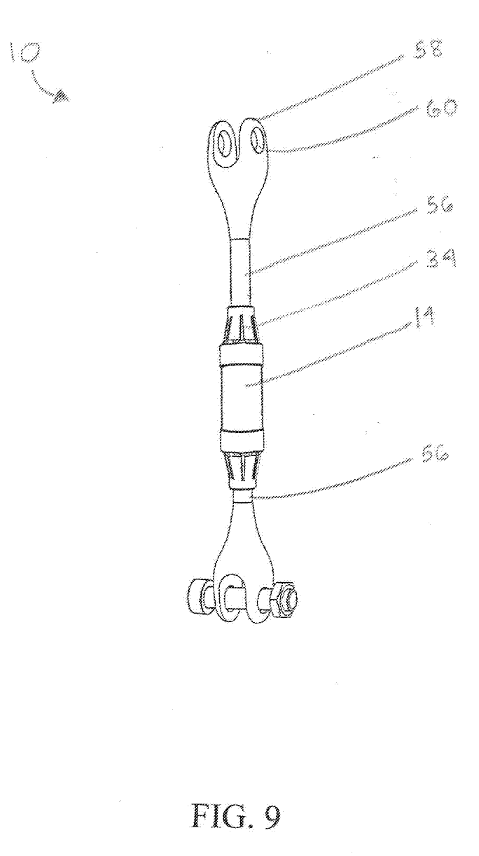

The system 10, as shown in FIGS. 1-11, is comprised of an actuating recoiling strut 12 with a housing 14 and an actuating rod 56. The housing 14, as shown in FIGS. 1-9, comprises a female receiver 16 with a first end 18 having an opening 20, a second end 22 having an opening 24 with internal threads 26, an external surface 28, and an internal channel 30. The housing 14 also comprises a male cap 34 with a first end 36 having an opening 38 to an internal threaded cavity 40, a second end 44 with an external threaded section 48 and having an opening 50 to an internal channel 52, and an external surface 54. While the first end 18 of the female receiver 16 and the first end 36 of the male cap 34 are both shown as tapering inward, other dimensional shapes such as straight can also be effectively utilized. The opening 24 on the female receiver 16 is dimensioned to accept the external threaded section 48 on the male cap 34. The female receiver 16 and the male cap 34 are maintained together by screwing the male cap's external threaded section 48 into the opening 29 with internal threads 26 on the female receiver's second end 22. The housing is preferably made of a metal such as aluminum but can also be made of other materials including spun carbon fiber, stainless steel or composite materials, and the size of the housing 14 can vary depending on the requirements of use.

Located within the housing 14 is the actuating rod 56, as shown in FIGS. 1-5. The actuating rod 56 includes a first end 58 having an opening 60, and a second end 64. The actuating rod 56 is slideably situated within the housing's internal channels 28,52. The second end 64 terminates at the end of the male cap's internal channel. A portion of the rod 56 extends within the male cap's internal channel 52 and the remaining length of the rod 56 is within and extends through the internal channel 30 on the female receiver 16. The first end 58 of the rod 56 extends outward from the opening 20 on the female receiver's first end 18. Within the opening 20 on the rod 56 is a spherical bearing 62. Surrounding the actuating rod 56 is a compression spring 68, as shown in FIGS. 1-5, that facilitates the actuating movement of the rod 56 within and extending from the housing.

The spring 68 can be as long or short as required. Located adjacent the second end 64 of the actuating rod 56, is at least one internal spring adjustment space 72. As shown in FIG. 1, that allows the length of spring 68 and the resulting compressive force to be selectively adjusted for optimal functionality. Extending from the first end 36 of the male cap 34 is an adjustable attachment fitting 74 with a first end 76 having an opening 78, and a second end 84 with a threaded section 86.

The opening 38 and the internal threaded cavity 40 on the male cap's first end are dimensioned to accept the second end 84 and threaded section 86 of the attachment fitting 74. The fitting is attached to the housing 14 by screwing the fitting's second end 84 and threaded section 86 into the internal threaded cavity 40. The distance the fitting 74 extends outward from the housing 14 can be adjusted by the amount the fitting 74 is screwed into or out from the cavity. The first end 76 of the fitting also has a spherical bearing 80 within the opening 78.

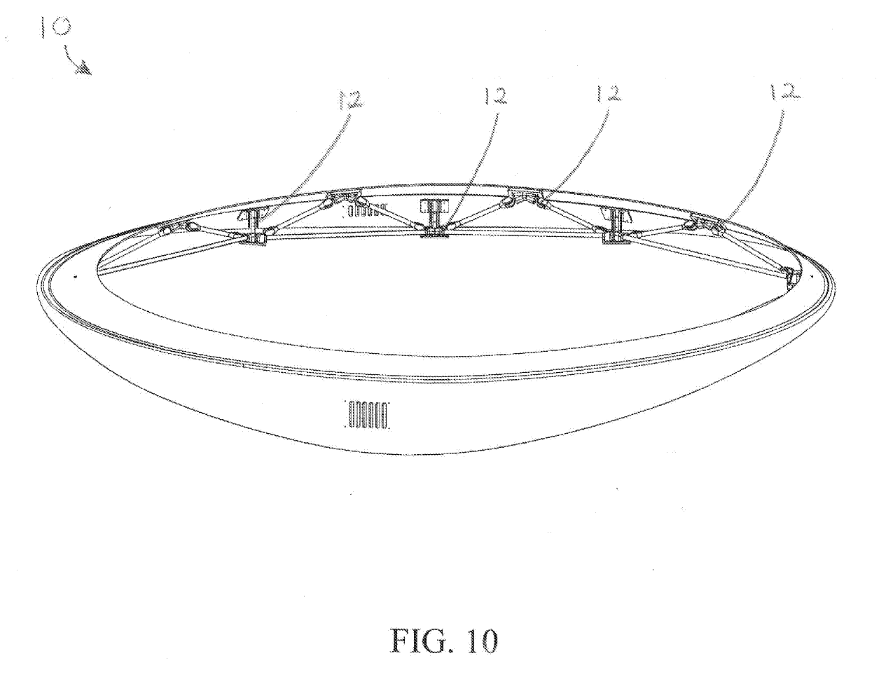

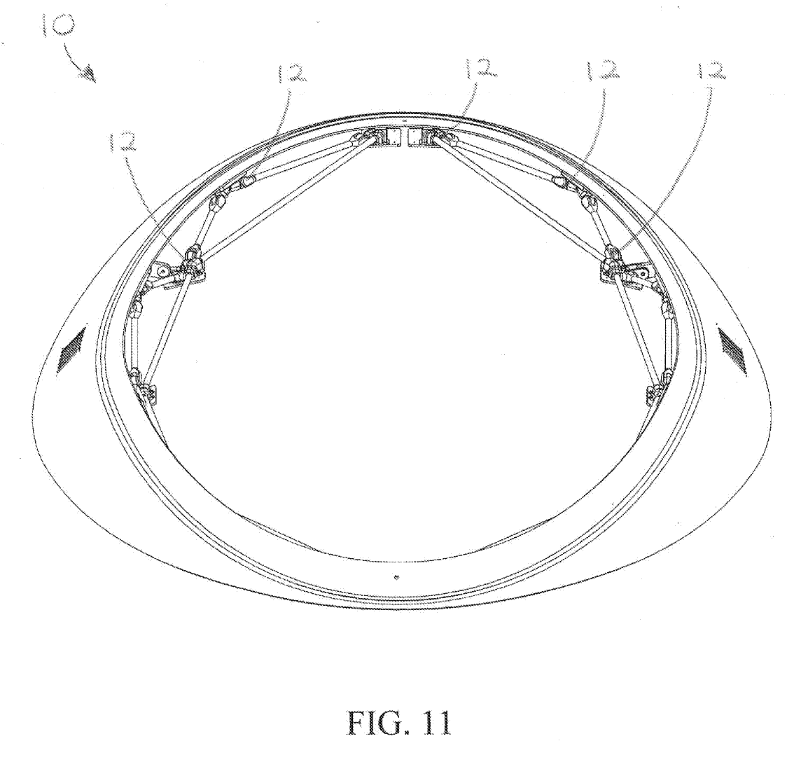

The first ends 58,76 of the actuating rod 56 and the attachment fitting 74 both function as attachment members for securing the actuating recoiling strut 12, as shown in FIGS. 1-9. While the strut 12 is shown utilizing spherical bearings on both ends, other movable or fixed attachment means/mountings can also be utilized, depending on the requirement(s) of the application. Whichever type of attachment means/mountings are utilized, they are adjustable, which allows the actuating recoiling strut 12 to be utilized on any type of crown structure designs for aircraft, and with all types of antenna or other SAT-COM mounting equipment or devices. Optimally, the actuating recoiling struts 12 can be used as a mounting attachment for an antenna adapter plate, ARINC 791 crown structure design or truss crown structure design, as shown in FIGS. 10-11.

The primary benefit of using the first design of the system 10 is that the actuating recoiling strut(s) 12 allows antenna adapter mounting flexibility to allow for fuselage expansion during pressurization. Under pressurization all aircraft fuselages grow by the amount of pressurization. An A320 and B737 airplane each have a fuselage diameter of approximately 152±4 inches. When the cabin is pressurized during a flight the diameter of the fuselage can enlarge by 0.3 inches resulting in fuselage expansion of 0.15 inches outward in every direction.

The actuating strut allows for this enlargement/expansion when joined to an aircraft's fixed fuselage fitting and a fixed antenna or SAT-COM communication system's antenna adapter plate, ARINC 791 attachments, truss or other designs of attachment systems. The strut(s) can be used with one side of an adapter plate hard mounted by attachment and the lugs actuating recoiling struts mounted to the opposite side of the attachment lugs. The actuating strut(s) can be mounted utilizing as many horizontal, vertical or angled shock absorbing struts required for a particular truss structure to support the size and weight of an adaptor plate, fairing, radome and/or antennas, as well as any form of SAT-COM connectivity device.

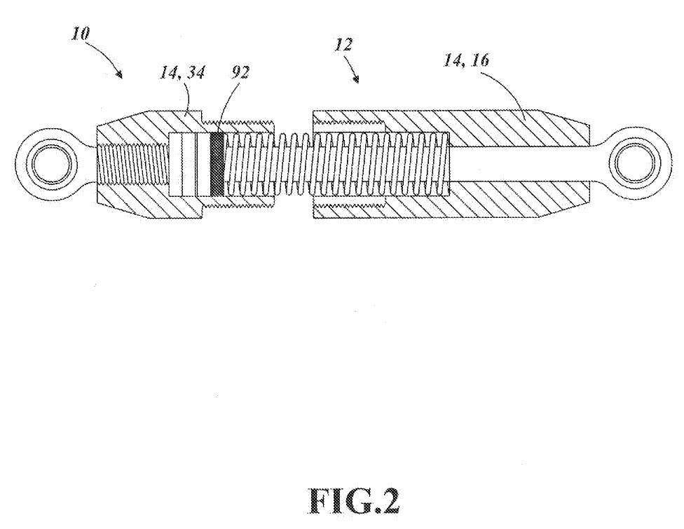

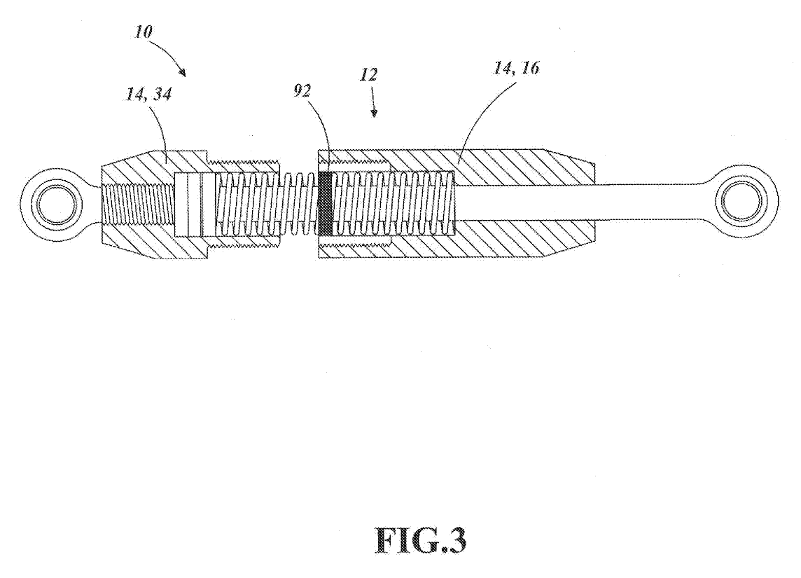

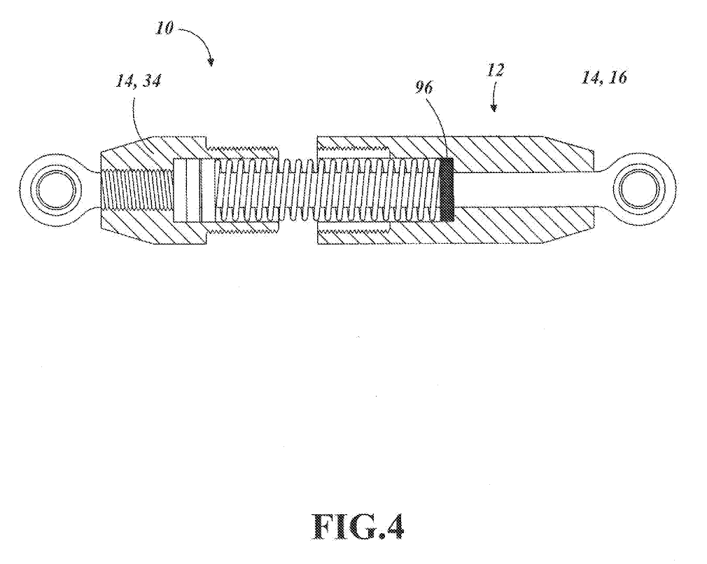

In the second functional design configuration, the truss reinforced radome crown structure utilizes actuating recoiling struts that can be used with any crown structure system to allow a crown structure to recoil when struck by a bird or to recoil in reaction to a rapid decompression event. The second design configuration, as shown in FIGS. 10 and 11, utilizes at least one specially placed actuating recoiling strut to facilitate action. The location 92 of the strut for pulling forces is shown in FIG. 2. The location 94 of the strut for pushing and pulling forces is shown in FIG. 3. The location 96 of the strut for pushing forces is shown in FIG. 4.

By mounting the adapter plate attachment lugs to slide mechanisms attached to the base of the adapter plate with an actuating recoiling strut mounted behind each lug attachment to the aft or forward of each attachment, as shown in FIG. 11, the radome crown structure is able to react and recoil, thereby protecting the structure from a bird strike incident or rapid decompression event which otherwise could cause severe damage to the aircraft's tail if the radome crown structure or a large section of the radome or crown structure were to break off and strike the tail. The force of the recoiling action absorbs the bird strike incident or rapid decompression event without allowing the incident or event to cause damage or loss of the aircraft and human life.

The second design of the radome crown structure is to be securely fixed and attached to an aircraft's airframe or fuselage to allow either the crown structure or components of the crown structure to recoil upon impact. This system provides shock protection to an airframe, radome and mounting attachments from a rapid decompression event, bird strike or any potentially damaging objects that could impact the crown structure at speeds required for flight. The system can be designed to be used in conjunction with any recoiling flexible means or materials, hydraulic shocks, gas or spring-loaded shocks or any flexible device such as rubber, flexible cords or spring-loaded tension adjustable actuating struts designed to absorb the force of the strike or incident. The recoiling system can be designed into any single attachment or multiple attachments between the affixed fittings supporting the fairing and radome, adapter plate or truss system, as shown in FIGS. 10 and 11, to the movable or sliding components of the truss system, adapter plate system or any combination of the adapter plate, skirt fairing and radome. Using shorter flexible attachments or spring loaded strut attachment links, the system can be modified and adapted to allow for fuselage expansion caused by cabin pressurization, protection from bird strike incident and/or a rapid decompression event when one or more actuating struts or flexible devices are mounted to any fixed member that secures the strut or flexible device between an aircraft fuselage and an adapter plate or crown structure.

The benefits/attributes of the second design are: Protects airframe, radome crown structure, tail, rear horizontal stabilizers and rear control surfaces from damage, is light weight, decreases costs and increases safety. An alternate embodiment in the second design, of the system would be to mount the shock absorbing recoiling struts to only the forward area of the truss crown structure. The forward crown structure attachments are replaced with actuating struts as in one version of the system as designed is only 4.4-inches tall and has a very low incident for bird strike impact. By replacing the upper forward facing rod link attachments with actuating recoiling struts, it allows for added flexibility of the aircraft's fairing and radome to absorb the forward shock of the bird strike or other impact.

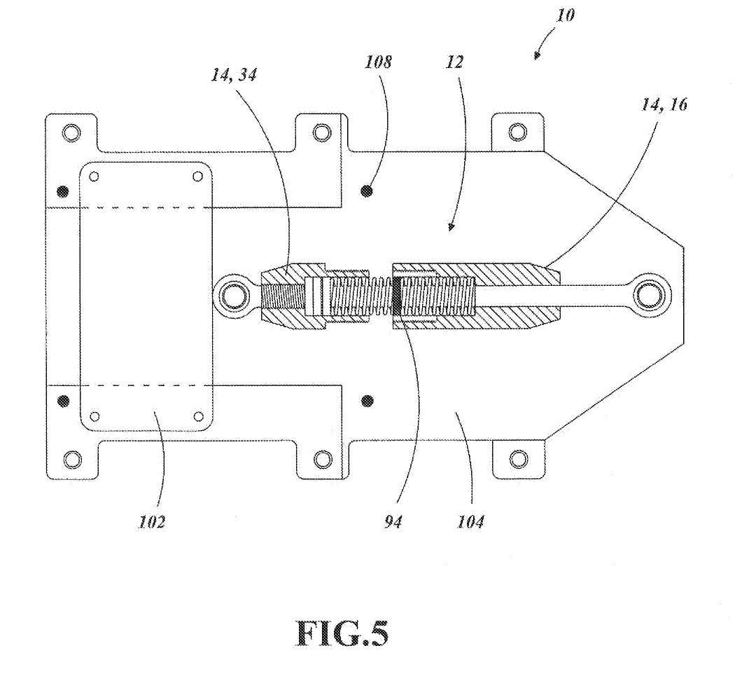

In the third functional design configuration of the system 10, as shown in FIG. 5, the actuating strut is attached to a slide mechanism that is mounted at either an actuating base plate 104 and/or attachment lugs 108. Alternately, when the system. 10 is utilized with an adapter plate that supports both antennas and/or an aircraft's fairing skirt and radome, the entire adapter plate functions as a single large unitary shock absorber, thereby enabling the entire crown structure to recoil upon an impact and then return to its initial position. The recoil action is accomplished by splitting an adapter plate into upper and lower plate sections and maintaining the two plate sections attached to and parallel with one another through the use of the slide mechanism which is designed to only allow the upper plate section to slide in the directions of forward and aft when an impact occurs. Attaching the actuating struts to the slide mechanism minimizes the force of the impact shock and allows the upper plate section to only slide or recoil by a preset amount of retention pressure. The longer the actuating rod and compression spring, the longer distance of allowed movement. The larger retentive force of the compression spring, the larger the retentive force that is required to cause a crown structure to recoil. The system can be adapted to accommodate the size and weight of any radome crown structure and absorb the force of a bird strike incident or survive a catastrophic event caused by rapid decompression under the radome crown structure.

In summary, the system 10 provides a solution to allow an actuating recoiling strut that is used with or without a fixed adapter plate to accommodate fuselage expansion during cabin pressurization and to protect against a bird strike incident or rapid decompression event if a fuselage tear occurs under the radome crown structure.

The first design allows antenna adapter mounting flexibility to allow for fuselage expansion during aircraft cabin pressurization. All aircraft fuselages expand when pressurized. A B-737 airplane at 74.080 and an A-320 airplane at 77.750 radiuses have a fuselage diameter of approximately 152-inches. When the cabin is pressurized to 9000 feet or the standard pressurization of a normal commercial flight, the diameter of the fuselage grows by 0.30-inches. The fuselage actually expands 0.15-inches in all circumferential directions. The actuating strut maintains the fixed antenna adapter in place by slightly collapsing while the fuselage expands and while the adapter plate remains in a fixed position. The system allows the attachment hardware to be maintained in a fixed and stationary position without the possibility of the hardware shearing or deforming as the fuselage expands under pressurization. This fixed/floating attachment system works for any connectivity device whether air to ground, air to air or for SAT-COM or newly developing laser connectivity systems. The actuating strut recoiling system will work with any externally mounted equipment requiring the attachment plate to be maintained in a fixed position while allowing the fuselage to expand while being pressurized. The system can be used with one side fixed or hard mounted and as the fuselage expands, the side with the actuating struts can become a flexible link. In many cases, the center of the antenna adapter is fixed and each side is allowed to float by using the actuating struts on adjacent sides.

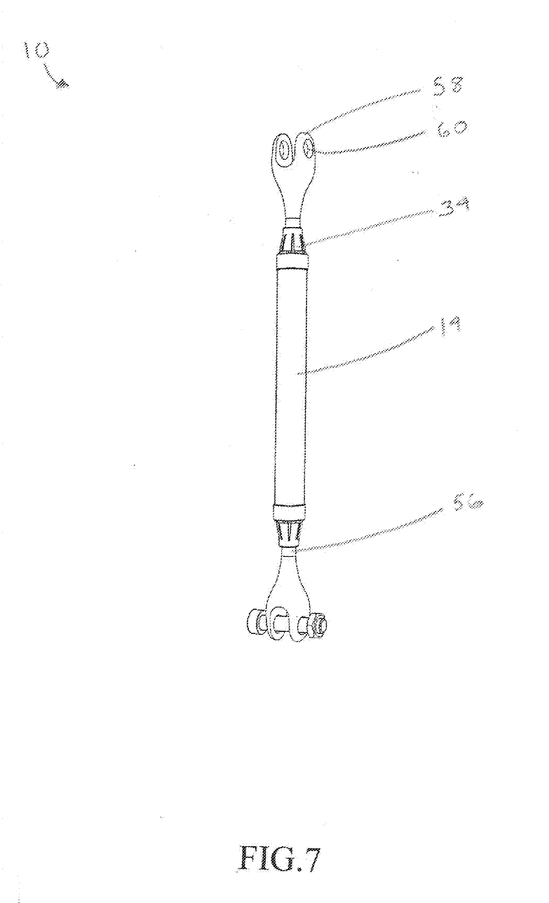

The second design of the system 10, as shown in FIGS. 7, 8 and 9, is used to allow a radome crown structure to absorb the severe shock of a bird strike incident or rapid decompression event which could become catastrophic if a section of the aircraft's radome or crown structure were to break off and strike the aircraft's tail or control surfaces. The second design allows either the entire crown structure or a section of the crown structure to recoil when struck allowing the force of the strike to be absorbed without breaking. The second design functions similar to the way a shock absorber works by absorbing the shock and recoiling back to its original position.

As previously disclosed, the third design of the system is by using actuating struts connected to a slide mechanism, as shown in FIG. 5, mounted at either the adapter plate attachment lugs or between the lugs and adapter plate, in some cases when the adapter plate supports both antennas and/or a fairing skirt and radome, the system turns the entire adapter plate into one large unitary shock absorber enabling the entire crown structure to recoil upon impact and then return back to its initial position.

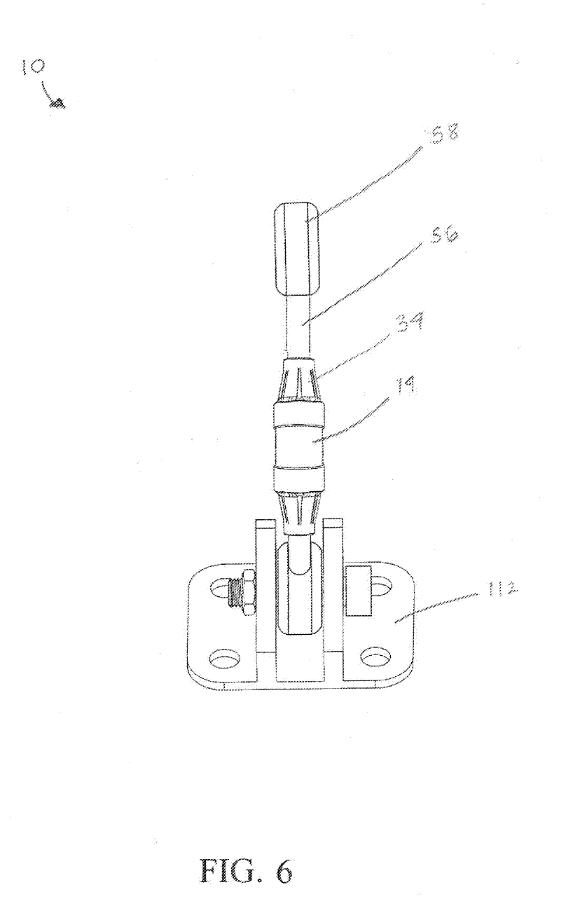

The system utilizes actuating struts as an element of vertical slide mechanisms 112 that are mounted at either adapter plate attachment lugs or between fuselage lugs, as shown in FIG. 6, and an adapter plate or skirt fairing, as shown in FIGS. 10 and 11. The vertical slide mechanisms allow the radome crown structure to recoil away from the fuselage in the event of a rapid decompression event, thus providing the entire crown structure with a gap to immediately evacuate the rapid decompression before returning to its initial position.

It should be noted that all designs of the system can use any type of flexible resilient material that is capable of absorbing and reacting to impact. After an impact, the material will allow a radome crown structure, or other structure to return to the original position prior to the impact.

Also, the system 10 has been designed and implemented both using and adapted for current technology. The system is intended to be adaptable to changes and improvements in technology while maintaining the functionality and utility disclosed herein.

While the invention has been described in detail and pictorially shown in the accompanying drawings it is not to be limited to such details, since many changes and modification may be made to the invention without departing from the spirit and the scope thereof.

1. A truss reinforced radome crown structure shock absorbing and recoiling system for mounting antenna adapter plates or other satellite communication (SAT COM) structures to an aircraft fuselage and allowing for pressurized expansion and contraction of the fuselage, wherein said system is comprised of an actuating recoiling strut including:
a) a housing comprising a female receiver with a first end having an opening, a second end having an opening with internal threads, an external surface, an internal channel, and a male cap with a first end having an opening to an internal threaded cavity, a second end with an external threaded section and having an opening to an internal channel, and an external surface, wherein the opening on said female receiver is dimensioned to accept the external threaded section on said male cap, wherein said female receiver and said male cap are maintained together by screwing said male cap's external threaded section into the opening with internal threads on said female receiver's second end, and
b) an actuating rod that is located within said housing and comprises a first end having an opening, and a second end, wherein said actuating rod is slideably situated within said housing's internal channels, and said rod's second end terminates at the end of said male cap's internal channel, wherein a length of said rod extends within said male cap's internal channel, a length of said rod is within and extends through the internal channel on said female receiver, and the first end of said rod outward from the opening on said female receiver's first end, wherein within the opening on said rod is a spherical bearing, and surrounding said rod is a compression spring, wherein said spring facilitates the actuating movement of said rod within and extending from said housing.

2. The truss reinforced radome crown structure shock absorbing and recoiling system as specified in claim 1 wherein said housing is made of metal.

3. The truss reinforced radome crown structure shock absorbing and recoiling system as specified in claim 2 wherein the metal is selected from the group consisting of aluminum, stainless steel, spun carbon fiber, or a composite material.

4. The truss reinforced radome crown structure shock absorbing and recoiling system as specified in claim 1 further comprising at least one internal spring adjustment space that allows the length of said compression spring, and the resulting compressive force, to be selectively adjusted.

5. The truss reinforced radome crown structure shock absorbing and recoiling system as specified in claim 1 further comprising an adjustable attachment fitting with a first end having an opening, and a second end with a threaded section, wherein said fitting is attached to said housing by screwing said fitting's second end and threaded section into the internal threaded cavity, wherein the distance said fitting extends outward from said housing is adjusted by the amount said fitting is screwed into or out from the cavity.

6. The truss reinforced radome crown structure shock absorbing and recoiling system as specified in claim 5 wherein said fitting's first end has a spherical bearing within the opening.

7. The truss reinforced radome crown structure shock absorbing and recoiling system as specified in claim 6 wherein the first ends of said actuating rod and said attachment fitting function as attachment members for securing said actuating recoiling strut.

8. The truss reinforced radome crown structure shock absorbing and recoiling system as specified in claim 1 wherein in lieu of spherical bearings, movable or fixed attachment means/mountings are utilized.

9. The truss reinforced radome crown structure shock absorbing and recoiling system as specified in claim 1 wherein one side of a radome or SAT-COM adapter plate is hard mounted by attachment lugs and said actuating recoiling struts secured to an opposite side of the lugs.

10. The truss reinforced radome crown structure shock absorbing and recoiling system as specified in claim 1 wherein multiple actuating recoiling struts are mounted horizontally, vertically or at an angle.

11. A truss reinforced radome crown structure shock absorbing and recoiling system that is secured to an aircraft's airframe or fuselage to allow a crown structure, or components of a crown structure, to recoil upon impact, wherein said system comprising at least one actuating recoiling strut with a housing, a male cap, an actuating rod, and a compression spring, wherein a truss structure adapter plate's attachment lugs are mounted to slide mechanisms attached to a base of the adapter plate, with said actuating recoiling strut mounted behind each lug attachment, aft or forward of each attachment, wherein said struts allow the radome crown structure to react and recoil, thereby protecting the structure from a bird strike incident or a rapid decompression event

12. The truss reinforced radome crown structure shock absorbing and recoiling system as specified in claim 11 wherein said actuating recoiling strut is located for pulling forces.

13. The truss reinforced radome crown structure shock absorbing and recoiling system as specified in claim 11 wherein said actuating recoiling strut is located for pushing and pulling forces.

14. The truss reinforced radome crown structure shock absorbing and recoiling system as specified in claim 11 wherein said actuating recoiling strut is located for pushing forces.

15. The truss reinforced radome crown structure shock absorbing and recoiling system as specified in claim 11 wherein said system is secured to movable or sliding components of a truss system, adapter plate, skirt fairing, or radome, or a combination of adapter plate, skirt fairing and radome.

16. The truss reinforced radome crown structure shock absorbing and recoiling system as specified in claim 11 wherein at least one actuating recoiling strut is mounted to a fixed member that secures said strut between an aircraft fuselage and an adapter plate or crown structure.

17. A truss reinforced radome crown structure shock absorbing and recoiling system that is secured to an aircraft's airframe or fuselage to allow a crown structure, or components of a crown structure, to recoil upon impact, wherein said system comprises at least one actuating recoiling strut with a housing, a male cap, and actuating rod, and a compression spring, wherein said actuating recoiling strut is attached to a slide mechanism which is mounted at an actuating base plate or at attachment lugs, wherein recoiling action is accomplished by splitting an adapter plate into upper and lower plate sections, and maintaining the two plate sections attached to and parallel with one another through the use of said slide mechanism which al lows only the upper plate section to slide in the directions of forward and aft when an impact occurs, wherein said struts attached to said slide mechanism minimizes the force of the impact shock and allows the upper plate section to only slide or recoil by a preset amount of retention pressure.

18. The truss reinforced radome crown structure shock absorbing and recoiling system as specified in claim 17 wherein the longer the actuating rod and compression spring, the longer the distance of allowed movement.

19. The truss reinforced radome crown structure shock absorbing and recoiling system as specified in claim 17 wherein the larger the retentive force of the spring, the larger the retentive force that is required to cause a crown structure to recoil.

20. The truss reinforced radome crown structure shock absorbing and recoiling system as specified in claim 17 wherein when an adapter plate supports both antennas and a fairing skirt with a radome, said system causes the adapter plate to function as a single unitary shock absorber that enables an entire crown structure to recoil upon impact and then return back to initial position.
